(19) United States
(12) Patent Application Publication
(10) Pub. No.: US 2016/0107833 A1
(43) Pub. Date: Apr. 21, 2016

(54) Versatile Debris Collector

(71) Applicant: Pamela A. Schvey, Naples, FL (US)

(72) Inventor: Pamela A. Schvey, Naples, FL (US)

(21) Appl. No.: 14/514,705

(22) Filed: Oct. 15, 2014

(51) Int. Cl. B65F 1/00; B65D 30/20; B65D 33/14; B65D 30/28

(52) U.S. Cl. CPC B65F 1/0013; B65D 31/18; B65D 31/10; B65D 33/14; B65F 2240/137; B65F 2250/108; B65F 2250/114; B65F 2230/152

(57) ABSTRACT

The inventive concept is directed to a catcher to catch debris incident with work done in a work location. The catcher includes an opening pouch that is placed below where a work is done, such as drilling or cutting on a dry wall. The catcher is constructed of a sheet of material, such a paper or plastic. The sheet is folded upon itself to form a front and a rear wall. The left and right edges of the front wall are folded into triangles toward the rear wall to thereby induce a self tension to automatically open the catcher into a pouch to receive the debris created by work performed. The rear of the wall of the catcher on its upper edge has a releasable glue strip attached thereto to be placed below of work project to be performed.

### BACKGROUND OF THE INVENTION

This invention is directed to the work performed by a handyman or craftsman that results in creating certain kinds of debris. Such debris is ending up on the floor when working on a wall or again on the floor when the work is being performed on a work table. One way to collect the resulting debris is using a drop-cloth on the floor or using a vacuum cleaner once the work is being performed or simply letting the debris fall where it may and by using a broom or a dust pan to clean up the resulting debris or dust. The clean up, after the work has been done, is very time consuming and labor intensive.

### BRIEF DESCRIPTION OF THE INVENTION

The inventive concept involves the use of a catcher, a pocket or a pouch which is removably being placed below the work to be performed. Such work to be performed includes dust or debris created by drilling into a wall, for example, installing or changing wall mollies, picture hooks, nails, drapery brackets, curtain rods, electrical outlets, light switches, wall lights, wall TV mounts. This debris catcher can also be used and comes in handy on a craftsman table, where a lot of dust and debris is created. As will be described below, the catcher would be attached to an edge of the table and the debris could simply be swept into it.

### BRIEF DESCRIPTION OF THE INVENTION

The debris catcher consists basically of a paper or plastic pouch that has a glue type on an upper surface on its back. The paper is folded in such a manner that it will open itself when attached to a wall surface. The catcher or pouch is initially made of a rectangular piece of somewhat stiff paper. It is then double folded upon itself. The upper right and left edges of the front double fold are then folded in a triangular manner and fastened to the prevailing back side by way of a stiff glue strip which will close the pouch at their edges and because of the glue strip being somewhat stiff, it will move the front double fold forward by self-induced tension to thereby open the pouch and form an upwardly facing opening representing an open pouch. The upper and backwardly facing half of the folded paper has a glue substance attached thereto. This glue substance is similar to the glue strip used on the known “Post-It” note pads. Is is well known to have adhesive power but can easily be removed without leaving any glue substance behind and or leaving the surface to which it was attached to be clean of any glue or any other marks.

### DESCRIPTION OF THE DRAWINGS

FIG. 1 is a top view of the debris catcher installed;

FIG. 2 is a front view of the debris catcher;

FIGS. 3-6 show progressive views of assembling the catcher;

FIGS. 7 and 8 show a view of folding the edges of the forward sheet;

FIG. 9 is a side view of the final assembly;

### DETAILED DESCRIPTION OF THE INVENTION

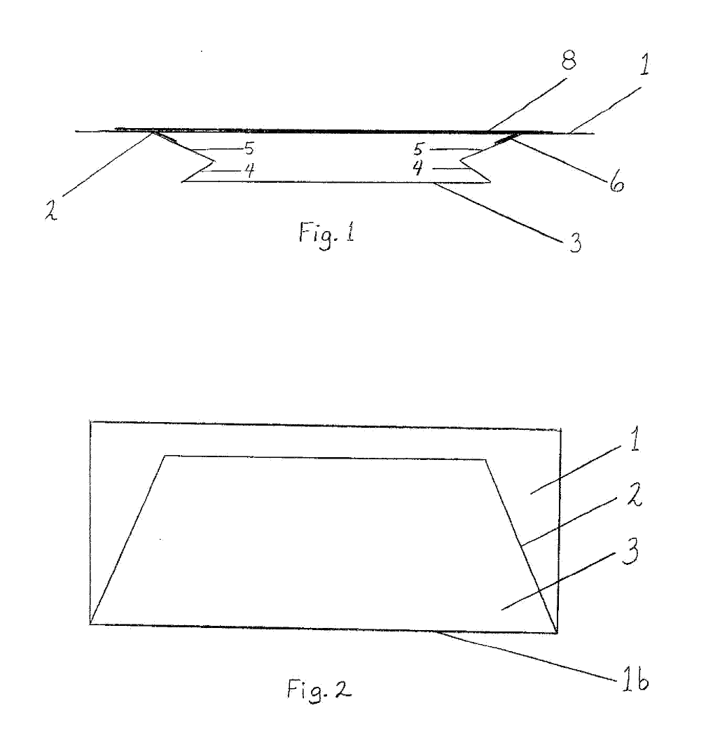

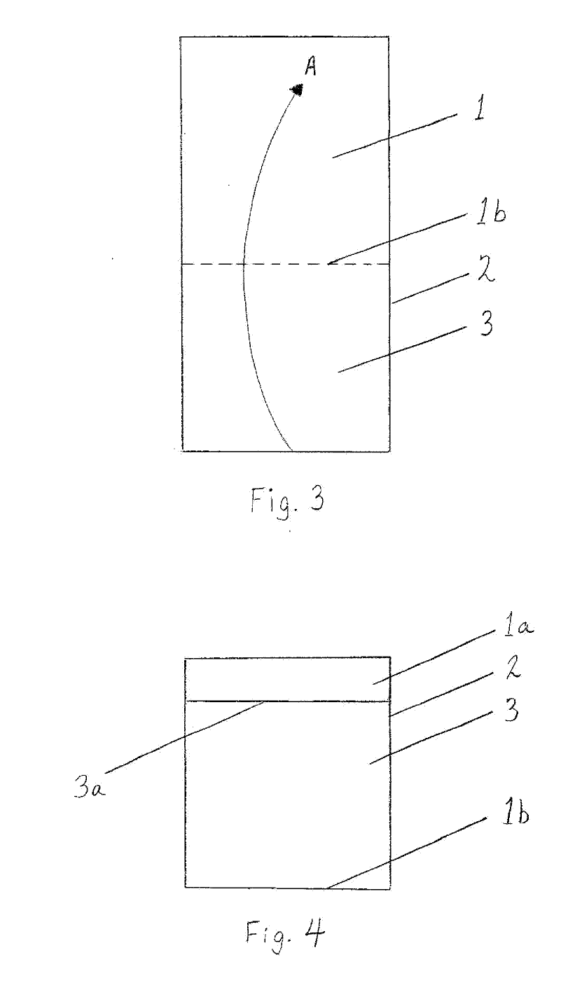

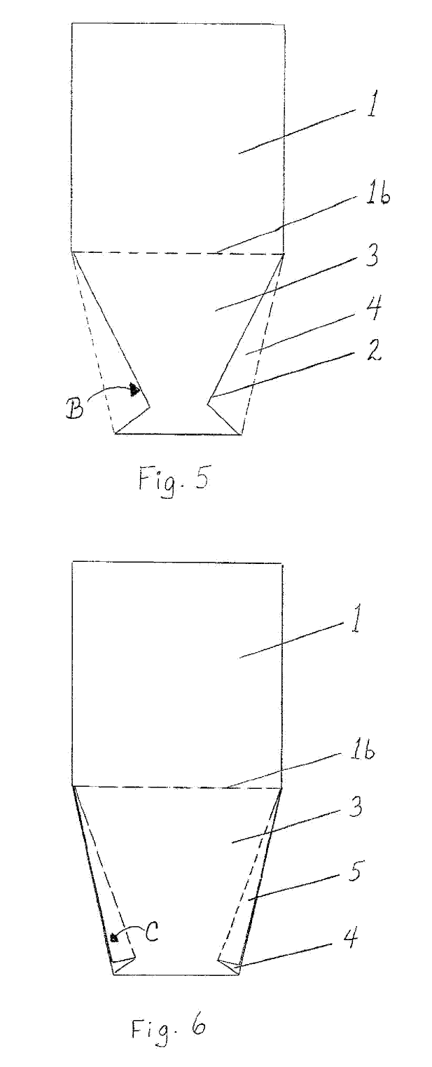

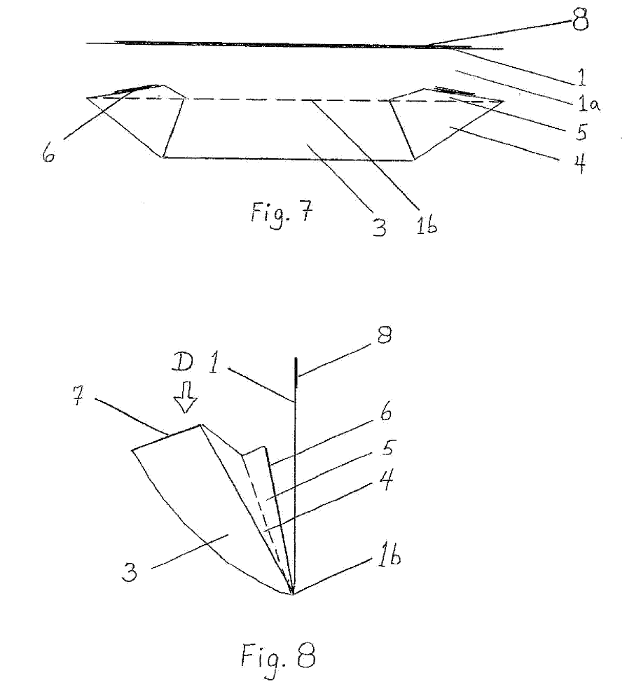

FIG. 1 is a top view of the debris catcher having a strap of adhesive glue 8 at the top edge of the debris catcher or pouch rear wall. The pouch consists of a folded or doubled over paper ending in a back sheet 1 and front sheet 3. The glue strip 8 is used to attach the debris catcher to any surface below where any work is being performed. The glue strip can be similar to the glue strip that is being used on the well known “Post-It” sheets that can be found in many uses. Instead of using a glue strip the catcher pouch can also be attached to a wall by using masking tape or printers tape. This will lessen the cost of manufacturing the catcher. FIG. 1 also shows the triangular creations on the edges of the front sheet 3, where the edges 2 are being turned inwardly in a triangular fashion as shown in FIG. 2. Once turned inwardly, each of the triangular sections, shown at 4, is turned in one more time in a triangular fashion as shown at 5. This creates an induced tension. As a result the induced tension will automatically open the entrance to the pouch being ready to receive any debris that is falling from above where the debris catcher has been installed. In order to fortify and to stabilize the folded triangles, the inner edge of backfolded edge 5 may be attached to the back wall by way of a stiff glue strip 6. See FIG. 1. FIG. 2, as a front view, also shows the fold line lb after creating the front and the rear walls. The following FIGS. 3-7 show a sequence of constructing or shaping the debris catcher. In a front view in FIG. 3, there is shown a rectangular piece of paper. It is recommended that this paper be of somewhat stiff quality in order to assume and hold its shape for the intended use. It is folded upward as indicated by arrow A. FIG. 4, front view, shows a section 1 which will become a back sheet or back wall. At 3 is shown the front wall forming the pouch once it is assembled. Both the back wall 1 and the front wall 3 are formed by the fold line lb. The front wall 3 is somewhat folded a little shorter at its top than the rear wall 1 which is shown at 3a leaving a top margin la on back wall 1. FIG. 5, front view, shows the upper edges 2 of the front wall 3 folded back in a triangular fashion 4 as is shown by the arrow B. In FIG. 6, front view, there is shown a further fold 5 on each of the triangular folds 4 as is indicated by the arrow C. These folds are further shown by the top view of FIG. 7. FIG. 8 shows a side view of the various folds. The back of rear wall 1 is shown to have adhered thereto a strip of glue at 8. As mentioned above, this strip of glue can take the form of the glue strip that is used in the well known “Post-it” notes because it adheres well but once removed from any place it leaves no marks or stains. It also has been mentioned above that this glue strip can be replaced by push pins masking tape or printers tape. Also in FIG. 8 is shown the opened or extended pocket 7. Also with reference to FIG. 8 it is noted that there is a glue strip 6 which will attach a portion of the folded triangles 5 to the back wall. This will seal the pocket 7 at its side edges. It is also recommended that this glue strip 6 be somewhat stiff. This will introduce a self-tension into the thus created pouch to aid in opening the pouch to receive any debris unemcumbered.

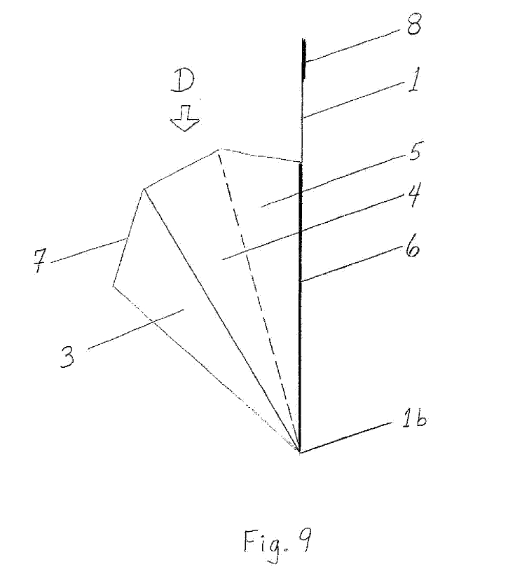

FIG. 8 is a showing of a side view of the debris catcher with a forwardly open pouch shown by arrow D, with the glue strip 6 not attached yet to the rear wall 1. FIG. 9 is the same side view as FIG. 8 but the second triangular half at 5 is attached to the rear wall 1 by way of the glue strip 6 which makes the open pouch complete. So far the debris catcher has been explained to be used on a flat wall. The same principle of use can be extended to an entirely different environment with the same results. A craftsman is working on a project located on a work bench. The work or hobby projects create a lot of debris by way of cutting, filing etc. This debris catcher can be attached to the edge of the table with the back wall being level with the top surface of the table. Any accumulated dust, dirt or debris can be swept or wiped into the open pouch of the catcher. Another environment can be found in the kitchen having a countertop. Preparation of food creates a lot of debris such as shavings of vegetables, bone fragments etc. The debris catcher can be used in the same manner as was explained above with regard to a workshop of a craftsman. It is also possible to make the front and back walls out of a plastics material. While in this use a self-induced tension may not open the pouch by itself, the pouch could be opened by hand once the catcher is attached to a wall or a work table. The use of plastic material may result in a much lower cost.

What I claim is:

1. A debris catcher for use in a working environment, said catcher consisting of a sheet of material being folded into a doubled sheet and forming a front and a rear wall, left and right edges of said front wall being folded into triangles, said triangles are folded in half again into a second set of triangles, means for fastening said half triangles to a rear wall forming a pouch when opened.

2. The debris catcher of claim I, including means for fastening a rear of said top of said back wall in the vicinity of a work project.

3. The debris catcher of claim 2, wherein said means for fastening is a glue strip.

4. The debris catcher of claim 1, wherein said sheet of material is a sheet of paper.

5. The debris catcher of claim 1, wherein said sheet of material is a sheet of plastic.
